(19) United States
(12) Patent Application Publication
(10) Pub. No.: US 2014/0358318 A1
(43) Pub. Date: Dec. 4, 2014

(54) THERMAL CONTROL METHOD AND THERMAL CONTROL MODULE APPLICABLE IN A PORTABLE ELECTRONIC DEVICE

(71) Applicant: MEDIATEK Inc., Hsin-Chu (TW)

(72) Inventors: Kang-Chih Lin, Zhubei City (TW); Chung-Jen Kuo, Hsin-Chu City (TW)

(21) Appl. No.: 13/909,145

(22) Filed: Jun. 4, 2013

(51) Int. Cl. G05D 23/19

(52) U.S. Cl. CPC G05D 23/1927
USPC 700/300

(57) ABSTRACT

A thermal control method for a portable electronic device includes: providing at least one capacitive temperature sensor corresponding to at least one particular location of the outside surface of the portable electronic device, the capacitive temperature sensor having a thermal characteristic which is temperature sensitive; monitoring the change of the thermal characteristic of the at least one capacitive temperature sensor to estimate the temperature of the at least one particular location; and deciding whether to perform thermal throttling in the portable electronic device based on the estimated temperature of the particular location.

### TECHNICAL FIELD

The application relates in general to a thermal control method and a thermal control module applicable in a portable electronic device.

### BACKGROUND

Electronic products usually generate heat during operation, which may result in reduced reliability of the products over time. Accordingly, measuring and controlling the thermal characteristics of the products are important. For maintaining the performance of the products, thermal control measures are required in electronic products in order not to frustrate user's experience under various operating conditions.

Thermal control is particularly challenging for consumer portable electronic devices that are held and carried by their users while in operation, such as cellular telephones, smart phones, digital media players and the like. Such devices are usually small and densely packed, so that heat may not be easily dissipated. Furthermore, such devices are frequently in intimate contact with users' skin, so that customer satisfaction concerns arise if the thermal characteristics of the device are not properly controlled.

In electric products, temperature sensors may sense temperature at various locations thereof. The temperature sensors may be deposited in an IC (integrated circuit) or on a PCB (printed circuit board), for example. Thermal control or management algorithms may be developed in the factory based on data collected from these temperature sensors while operating the device in its various normal operating modes.

However, desired spots whose temperature needs to be carefully monitored or regulated in order not to exceed a specified temperature limit may be located at particular points where it is difficult to deposit sensors. For example, the particular points may be located on the housing of a smart phone device. These spots may be generally referred to as critical points or hotspots. The temperature relationship of the critical points and the temperature sensors may be pre-determined as thermal model, which may be used to estimate the “virtual temperature” at these critical points, based on the temperature data received from temperature sensors located elsewhere in the device.

Thermal throttling may then be taken by using this estimated temperature data (together with temperature data from the temperature sensors and data indicating current power consumption levels of the components in the device), to mitigate the thermal behavior at the critical points. For example, thermal throttling may be performed by lowering operating frequency or operating voltage of the components (for example, CPU, modem module, graphic IC, and the like, which consume a lot of power and therefore generate much heat) to lower the temperature of the critical points.

However, the sensing results of thermal sensors within an IC may be affected by the heat generated from the IC itself, and sensing results of thermal sensors on the PCB may also be affected by other components which generate heat (heating source(s)) on the PCB. Thus, the temperature of the critical points may be wrongly estimated since these sensing results may not correctly reflect the temperature of the critical points and thus thermal throttling may malfunction.

Besides, for thermal throttling, the correlation between the sensing result of thermal sensors and the real temperature of the critical points has to be pre-determined for the thermal model. However, it may need a lot of thermal tests to obtain the correlation, which is time-consuming.

Another approach for thermal throttling is to place IR (infrared) sensors on or below the critical points on the housing. It needs precisely locating the critical points. If there is more than one critical point to be monitored, then more IR sensors are needed, which is not cost-effective.

### SUMMARY

The application is directed to a surface temperature control via capacitive temperature sensors. The capacitive temperature sensors may be provided on particular locations of the outside surface or on a back cover of a portable electronic device.

An embodiment of the application provides a thermal control method for a portable electronic device. The method includes: providing at least one capacitive temperature sensor corresponding to at least one particular location of the outside surface of the portable electronic device, the capacitive temperature sensor having a thermal characteristic which is temperature sensitive; monitoring the change of the thermal characteristic of the at least one capacitive temperature sensor to estimate the temperature of the at least one particular location; and deciding whether to perform thermal throttling in the portable electronic device based on the estimated temperature of the particular location.

An alternative embodiment of the application provides a thermal control module in a portable electronic device. The portable electronic device includes: at least one capacitive temperature sensor formed on at least one particular location of the outside surface of the portable electronic device, the capacitive temperature sensor having a thermal characteristic which is temperature sensitive; and a touch panel having a plurality of touch sensing cells. The thermal control module includes: a controller, coupled to the capacitive temperature sensor and the touch sensing cells, for determining an estimated temperature of the particular location based on a sensing result from the at least one capacitive temperature sensor and determining at least one touch position based on sensing results from the touch sensing cells; and a thermal manager, coupled to the controller, for managing thermal throttling in the portable electronic device based on the estimated temperature of the particular location.

### BRIEF DESCRIPTION OF THE DRAWINGS

FIG. 1A shows a top view of a portable electronic device according to an embodiment of the application.

FIG. 1B shows cell patterns of a touch panel of the portable electronic device in FIG. 1A.

FIG. 1C shows a side view of capacitive temperature sensors formed in a speaker region of the portable electronic device in FIG. 1A.

FIG. 1D shows a side view of the touch sensing cells of the main sensing area along line L0 and L0′ in FIG. 1B.

FIG. 2 shows a flow chart for a touch controller according to the embodiment of the application.

FIG. 3A shows a heat spreader and capacitive temperature sensors according to another embodiment of the application.

FIG. 3B shows an enlarged cross-section of the capacitive temperature sensor in FIG. 3A along line L1-L1′.

FIG. 4 shows a system power control flow based on temperature sensing according to the embodiments of the application.

FIG. 5 shows a functional block diagram of a portable electronic device according to an embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In embodiments of the application, capacitive temperature sensors are provided at hotspots or particular locations of the outside surface of the portable electronic device which are under temperature monitor. Capacitance of the capacitive temperature sensor is varied due to temperature change. In other words, the capacitive temperature sensor has a thermal characteristic (for example, the capacitance) which is temperature sensitive. Thus, by detecting capacitance of the capacitive temperature sensor, temperature at the particular location is detected.

Capacitance of a capacitor is expressed as: C=∈A/d wherein “∈” is a dielectric constant of a dielectric material between electrodes of the capacitor, “A” is an area of the electrodes and “d” is a distance between the electrodes.

In some embodiments of the application, capacitive temperature sensor is formed by using dielectric material whose dielectric constant is temperature sensitive. If temperature around the capacitive temperature sensor changes, the dielectric constant of the dielectric material is changed, and thus the capacitance of the capacitive temperature sensor is changed accordingly. In some embodiments of the application, the area of the electrodes “A” or distance between the electrodes “d” is changed with the temperature, which causes the capacitance of the capacitive temperature sensor changed accordingly.

Therefore, in the embodiment, by forming capacitive temperature sensors at hotspots or particular locations of the outside surface of the portable electronic device, the capacitance change of the capacitive temperature sensor due to temperature change is monitored and thus temperature at the particular locations is monitored. System power may be controlled based on the temperature monitoring result(s).

In the embodiments, the capacitive temperature sensor is formed on the particular location, for example, an outside surface of the portable electronic device that is touched by a user of the portable electronic device, or an outside surface of the portable electronic device that is near the edge of the portable electronic device, or an outside surface of the portable electronic device that is away from the location of at least one heat source of the portable electronic device, or an outside surface of the portable electronic device that is near a speaker of the portable electronic device, or a heat spreader of a back cover of the portable electronic device.

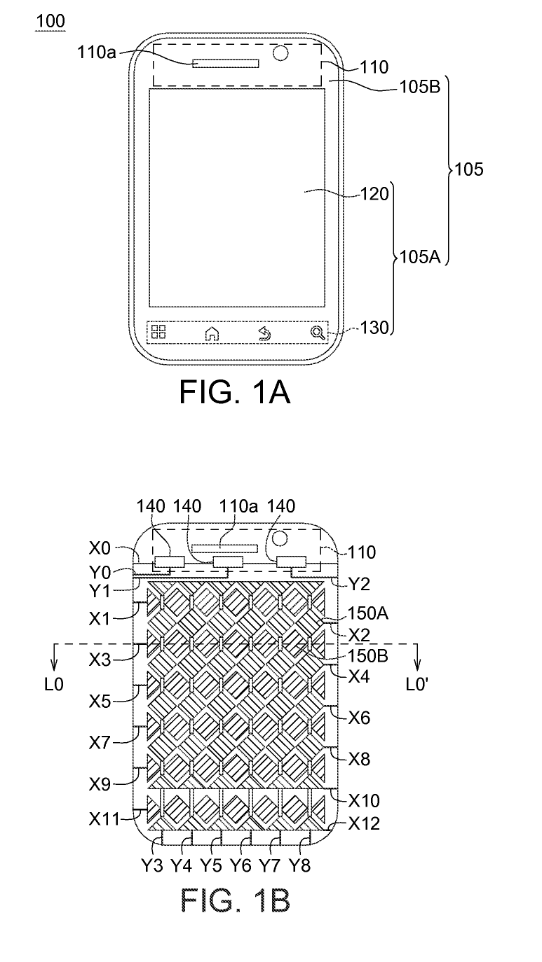

Please refer to FIG. 1A, which shows a top view of a portable electronic device 100 according to an embodiment of the application. As shown in FIG. 1A, the portable electronic device 100 includes a touch panel 105. The touch panel 105 includes a sensing area 105A and a non-sensing area 105B. The sensing area 105A at least includes a main sensing area 120 and a virtual key area 130. The main sensing area 120 also functions as a display area. The non-sensing area 105B is an area other than the sensing area 105A. The non-sensing area 105B at least includes a speaker region 110, an optional proximity sensor (which is not shown) and an optional digital camera (which is not shown). The speaker region 110 is the area around the speaker 110a. Preferably, the speaker region 110 does not overlap with the main sensing area 120. However, the embodiment is not limited thereto.

When users are telephoning, the speaker region 110 is close to users' ear and face, and the temperature at the speaker region 110 should be monitored. The temperature of at least one hotspot or at least one particular location is monitored in the speaker region 110, and at least one capacitive temperature sensor is formed in the at least one hotspot or the at least one particular location in the speaker region 110.

Here, hotspot may be on the touch panel 105, a back cover or even a side plane of the portable electronic device 100. Thus, if the hotspot is on the sensing area 105A of the touch panel 105, then touch sensing cells at the hotspot of the sensing area 105A may have the same cell pattern as the capacitive temperature sensor of the sensing area 105A.

However, the embodiment is not limited by positions of the capacitive temperature sensors described above. The capacitive temperature sensor(s) may be located at other hotspot(s) whose temperature needs to be monitored.

FIG. 1B shows cell patterns of the touch panel 105 of the portable electronic device 100 in FIG. 1A. As shown in FIG. 1B, at least one capacitive temperature sensor 140 (for example, three capacitive temperature sensors 140) is formed in the speaker region 110. Diamond-shape touch sensing cells 150A and 150B are for touch sensing. The capacitive temperature sensors 140 may have different cell patterns from the diamond-shape touch sensing cells 150A and 150B. Or, in other possible embodiments of the application, the capacitive temperature sensors 140 may have the same cell patterns as the touch sensing cells of the main sensing area 120; and sensing/driving of the capacitive temperature sensors may be different from sensing/driving of the touch sensing cells of the main sensing area 120.

Although FIG. 1B shows thirteen X lines X0˜X12 and nine Y lines Y0˜Y8, the application is not limited thereby. The X line X0 and the Y lines Y0˜Y2 are used for temperature sensing; and the X lines X1˜X12 and the Y lines Y3˜Y8 are used for touch sensing. The X lines may be referred as driving lines and the Y lines may be referred as scanning lines.

The capacitive temperature sensors 140 are coupled or connected to a touch controller (not shown) via the X line X0 and the Y lines Y0˜Y2; and the diamond-shape touch sensing cells 150A and 150B are coupled or connected to the touch controller via the X lines X1˜X12 and the Y lines Y3˜Y8.

Still further, in the embodiment, not only the temperature at the particular location(s) can be monitored but also the environment temperature can be monitored. If the capacitive temperature sensor(s) is formed at somewhere away from the heat sources and not affected by heat generated from the heat sources, the capacitive temperature sensor may be used to monitor the environment temperature.

FIG. 1C shows a side view of the capacitive temperature sensors 140 formed in the speaker region 110. The Y lines Y0˜Y2 for temperature sensing are coated on a film 181. The X line X0 for temperature sensing is coated on a film 183. An adhesive 182 is filled between the films 181 and 183, for adhering the films 181 and 183. An adhesive 184 is filled between a cover lens 185 and the film 183, for adhering the cover lens 185 and the film 183.

The X line X0 and one of Y lines Y0˜Y2 form electrodes of the capacitive temperature sensor 140. One of the electrodes of the capacitive temperature sensor is a plate electrode. For example, the X line X0 is a plate electrode. When the X line X0 is applied by a DC level, the X line X0 also functions as a shield which prevents the capacitance of the capacitive temperature sensors from being varied when the speaker region 110 is touched. The film 183 and the adhesive 182 function as dielectric layers of the capacitive temperature sensor. Further, material of the film 183 and the adhesive 182 may have high thermal expansion or high temperature-dependent dielectric constant to enhance the temperature sensing capability of the capacitive temperature sensor 140.

FIG. 1D shows a side view of the touch sensing cells 150A/150B of the main sensing area 120 along line L0 and L0′ in FIG. 1B. The Y lines Y3˜Y8 for touch sensing are coated on the film 183. The X line X3 for touch sensing is coated on the film 181. The X line X3 and one of the Y lines Y3˜Y8 form electrodes of the touch sensing cell 150B.

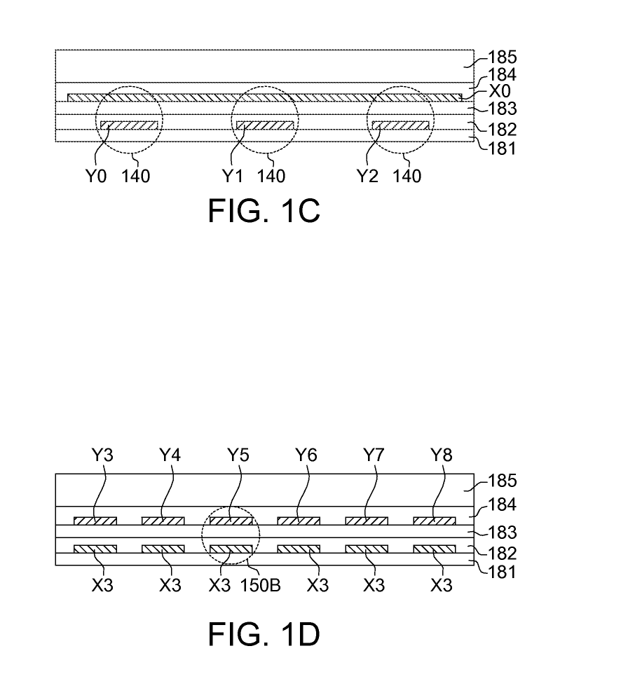

In the embodiment, the touch controller controls both touch sensing function and temperature sensing function. FIG. 2 shows a flow chart for the touch controller according to the embodiment of the application. In step 210, the X lines X0˜X12 are sequentially enabled and the Y lines Y0˜Y8 are sequentially scanned by the touch controller. The touch controller enables the X lines X0˜X12 by, for example, applying a DC level to the X lines X0˜X12.

In step 220, whether the sensing cell is in the temperature sensing area (for example but not limited by, the speaker region 110 in FIG. 1A) is judged, for example, by the touch controller. The touch sensing cells and the capacitive temperature sensors are at intersections of X lines and Y lines. For example, as shown in FIG. 1B, the touch sensing cells 150A˜150B are at intersections of X lines X1˜X12 and Y lines Y3˜Y8; and the capacitive temperature sensors 140 are at intersections of X line X0 and Y lines Y0˜Y2. In driving and scanning operations, the touch controller controls which X line is driven and which Y line is scanned. The touch controller may determine whether the cell is in the temperature sensing area or not. For example, if the X line X0 is driven and the Y line Y0 is scanned, the touch controller determines that the cell at the intersection of the X line X0 and the Y line Y0 (i.e. the capacitive temperature sensor 140) is in the temperature sensing area.

If the sensing cell is in the temperature sensing area, in step 230, during a temperature sensing period, the touch controller sequentially drives the X line X0 (which is coupled to the capacitive temperature sensor 140) and scans the Y lines Y0˜Y2 (which are coupled to the capacitive temperature sensor 140) for measuring capacitance change of the capacitive temperature sensor (which reflects the temperature at the particular location) to measure temperature. Besides, in step 230, the baseline calibration is disabled, wherein the baseline calibration (i.e. to update capacitance when there is no touch on the touch panel) is necessary for the touch sensing function in order to compensate the capacitance change due to temperature and other environmental factors. Because step 230 is for measuring temperature, the baseline calibration is disabled in step 230.

If the sensing cell is not in the temperature sensing area, in step 240, during a touch sensing period, the X lines X1˜X12 (which are coupled or connected to the touch sensing cells) are sequentially driven and the Y lines Y3˜Y8 (which are coupled or connected to the touch sensing cells) are sequentially scanned to measure capacitance change (which reflects the touch sensing) of the touch sensing cells. In step 240, the baseline calibration is enabled. Steps 210˜240 are performed by the touch controller.

In one embodiment of the application, for measuring capacitance of the capacitive temperature sensor, the capacitive temperature sensor is charged and discharged, and the touch controller measures the charging period and the discharging period. Of course, other implementations which measure the capacitance of the capacitive temperature sensor are applicable to the application and the application is not limited by how to measure the capacitance of the capacitive temperature sensor.

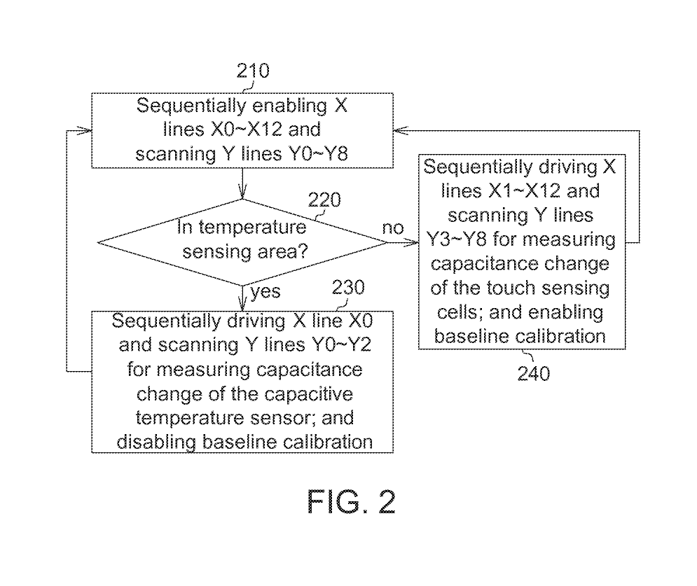

In another embodiment of the application, the capacitive temperature sensors are formed on a heat spreader of a back cover of the portable electronic device. FIG. 3A shows a heat spreader and the capacitive temperature sensors formed on the heat spreader according to this embodiment of the application. FIG. 3B shows an enlarged cross-section of the capacitive temperature sensor in FIG. 3A along line L1-L1′.

As shown in FIG. 3A, the heat spreader 320 is placed on the back cover 310. The heat spreader 320 is of metal material, for example, but not limited by, Copper (Cu). The capacitive temperature sensor 330 is formed on the spreader 320.

As shown in FIG. 3B, the capacitive temperature sensor 330 includes capacitor electrodes 331A and 331B and a dielectric layer 332. The capacitor electrode 331B is implemented by part of the heat spreader 320. The capacitor electrode 331A may be made of metal material, for example, but not limited by, Cu. The dielectric layer 332 is between the capacitor electrodes 331A and 331B and has large thermal expansion or high temperature dependent dielectric constant. If temperature around the capacitive temperature sensor 330 changes, the capacitance of the capacitive temperature sensor 330 also changes accordingly.

Besides, the capacitor electrodes 331A and 331B are coupled to a controller 334 (for example, which may be the touch controller performing steps 210˜240 of FIG. 2) via conductive pins 333. In FIG. 3B, a heat source 340 is also shown. The heat source 340 is, for example, an electronic circuit on a printed circuit board (PCB) 350. The electronic circuit on the PCB 350 is, for example, CPU, modem module, graphic IC, and the like, which consumes power and therefore generates heat.

When the heat source 340 generates heat, the heat is transmitted to the heat spreader 320. Because the heat spreader 320 is of metal material and has high thermal conductivity, heat from the heat source 340 spreads uniformly on the heat spreader 320, and the dielectric layer 332 is also heated. Thus, the temperature at the capacitive temperature sensor 330 is raised. The temperature change will be monitored by the controller 340 through the capacitive temperature sensor 330. For example, the capacitance of the capacitive temperature sensor 330 changes with temperature. For example but not limited by, the capacitance and the temperature of the capacitive temperature sensor may have a linear relationship. The controller 340 senses the capacitance change of the capacitive temperature sensor 330 and determines the temperature of the capacitive temperature sensor 330.

In details, when the heat source 340 generates heat, the dielectric layer 332 is also heated, the thickness of the dielectric layer 332 may be larger or the area of the dielectric layer 332 may be increased and thus the distance between the capacitor electrodes 331A and 331B is changed. Or, when the heat source 340 generates heat, the dielectric layer 332 is also heated and thus the dielectric constant of the dielectric layer 332 is changed. Due to the thickness or/and the area or/and the dielectric constant of the dielectric layer 332 is/are changed, the capacitance value of the capacitive temperature sensor 330 is changed.

The controller 340 senses the capacitance change of the capacitive temperature sensor 330 and determines an estimated temperature at the heat spreader 320. Because the heat spreader 320 is formed on the back cover 310 and thus the monitored temperature is substantially equivalent to the temperature at the back cover 310. Therefore, in the embodiment of the application, by providing capacitive temperature sensor(s) on the heat spreader of the back over of the portable electronic device, the temperature at the back cover is monitored through the capacitive temperature sensor(s).

Further, similarly, the capacitive temperature sensor(s) formed on the back cover may be used to monitor environment temperature of the portable electronic device if the capacitive temperature sensor(s) are formed at somewhere away from the heat source.

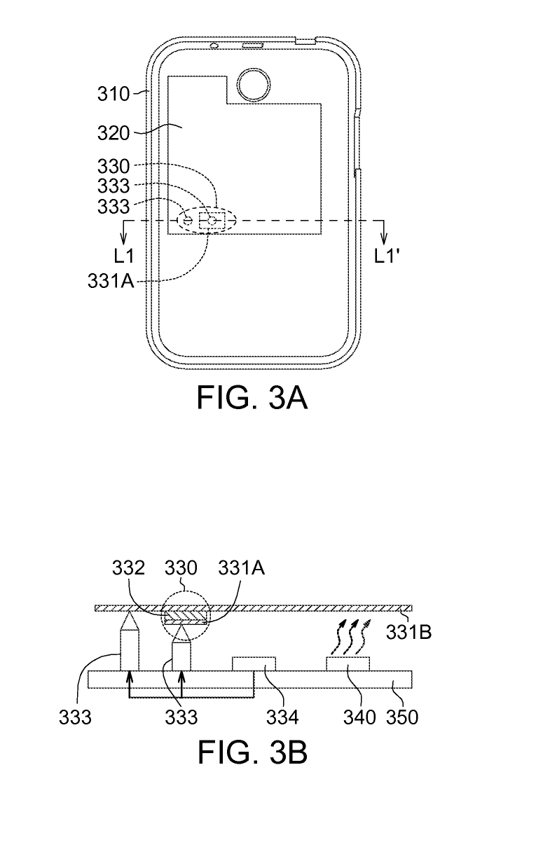

FIG. 4 shows a system power control flow based on the temperature sensing according to the embodiments of the application. FIG. 4 is used to decide whether to perform thermal throttling on the portable electronic device.

As shown in step 410, the temperature sensing results from the capacitive temperature sensors of the touch panel (for example, the capacitive temperature sensors in the speaker region) and/or the capacitive temperature sensor(s) on the heat spreader of the back cover are monitored to determine an estimated temperature of the particular location. Further, the temperature monitoring may be, for example, but not limited to, periodically performed.

In step 420, whether the estimated temperature of the particular location is larger than a threshold is judged. If yes in step 420, then step 430 is performed and the system power limit of the portable electronic device is reduced by one level. If no in step 420, then step 440 is performed and it is judged whether the system power of the portable electronic device is unconstrained. If no in step 440, then the flow returns to step 410. If yes in step 440 (which means the system power is unconstrained), then the flow goes to step 450 to increase the system power limit by one level. In other words, by steps 440 and 450, the system power limit may be gradually increased by a thermal management software (not shown) or a thermal management hardware (not shown). If the estimated temperature of the particular location is lower than the threshold and the system power is constrained by the thermal management software/hardware, then the thermal management software/hardware may increase the system power limit by one level (for example but not limited by, 200 mW). Steps 440 and 450 may be repeated until the system power is not constrained by the thermal management software/hardware.

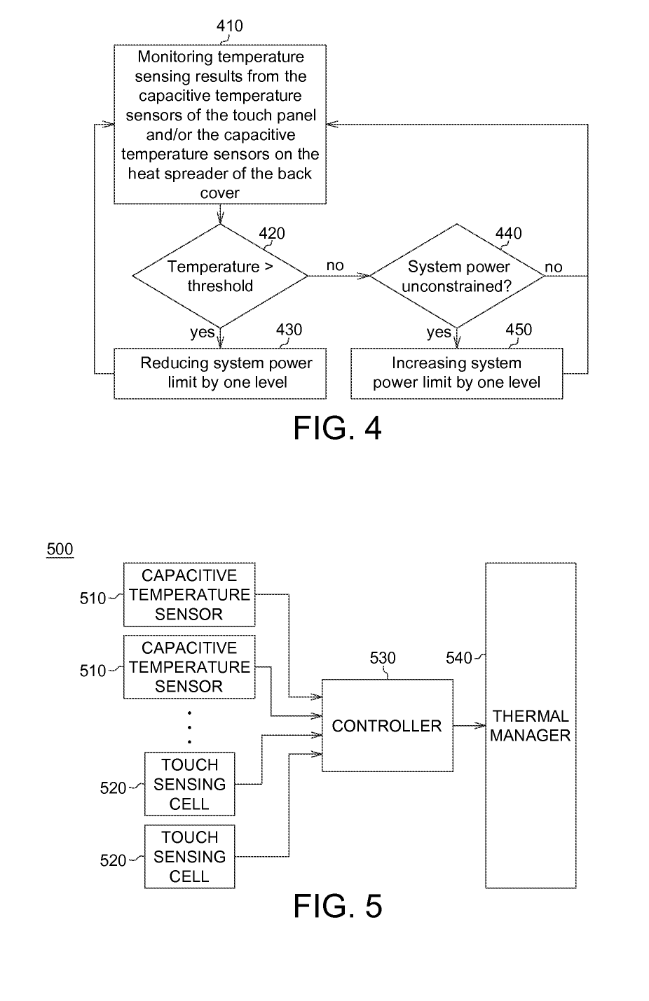

FIG. 5 shows a functional block diagram of a portable electronic device according to an embodiment of the application. As shown in FIG. 5, the portable electronic device 500 includes a plurality of capacitive temperature sensors 510, a plurality of touch sensing cells 520, a controller 530 and a thermal manager 540. The capacitive temperature sensors 510 and the touch sensing cells 520 may be, for example, the capacitive temperature sensors 140 and the diamond-shape touch sensing cells 150A˜150B, respectively, as shown in FIG. 1A˜FIG. 1C.

The controller 530 is for receiving sensing results from the capacitive temperature sensors 510 to determine the estimated temperature at the particular location; and for receiving sensing results from the touch sensing cells 520 to determine touch positions on the touch panel. The temperature determined by the controller 530 is sent to the thermal manager 540.

The thermal manager 540 makes a decision on whether to perform thermal throttling in the portable electronic device based on the determined temperature from the controller 530. The thermal manager 540 may be implemented by software or hardware.

When thermal throttling is performed, a power supply voltage of a data processing unit (for example, the CPU) is changed, the maximum transmit power of an RF antenna is changed, the operation frequency of the data processing unit is changed, or the display brightness of a display panel is changed. Other means for reducing the power consumption of the portable electronic device can also be adapted when performing the thermal throttling.

As discussed above, in the embodiments of the application, the capacitive temperature sensors formed on the hotspots or on the particular locations of the touch panel may monitor the temperature of the hotspots or the particular locations without negatively affecting the touch sensing function of the touch panel.

It is cost-effective to use part of the heat spreader of the back cover as a capacitor electrode of the capacitive temperature sensor formed on the back cover.

Still further, the temperature control and monitor in the embodiments of the application is performed without correlation experiments (which are used to find correlation between the hotspot temperature and the temperature sensed by the temperature sensors), which is time-effective.

It will be apparent to those skilled in the art that various modifications and variations can be made to the disclosed embodiments. It is intended that the specification and examples be considered as exemplary only, with a true scope of the application being indicated by the following claims and their equivalents.

What is claimed is:

1. A thermal control method for a portable electronic device, comprising:
providing at least one capacitive temperature sensor corresponding to at least one particular location of the outside surface of the portable electronic device, the capacitive temperature sensor having a thermal characteristic which is temperature sensitive;
monitoring the change of the thermal characteristic of the at least one capacitive temperature sensor to estimate the temperature of the at least one particular location; and
deciding whether to perform thermal throttling in the portable electronic device based on the estimated temperature of the particular location.

2. The thermal control method according to claim 1, wherein the at least one capacitive temperature sensor is provided on the particular location of the outside surface of the portable electronic device that is near the edge of the portable electronic device.

3. The thermal control method according to claim 1, wherein the at least one capacitive temperature sensor is provided on the particular location of the outside surface of the portable electronic device that is away from the location of at least one heat source of the portable electronic device.

4. The thermal control method according to claim 1, wherein the at least one capacitive temperature sensor is provided on the particular location that is near a speaker of the portable electronic device.

5. The thermal control method according to claim 1, wherein
the portable electronic device further comprises a touch panel, the touch panel having a sensing area and a non-sensing area, the sensing area having a plurality of touch sensing cells; and
the at least one capacitive temperature sensor has different patterns from the touch sensing cells or the at least one capacitive temperature sensor has the same patterns as the touch sensing cells.

6. The thermal control method according to claim 5, wherein the touch panel further comprises a plurality of driving lines and a plurality of scanning lines, each of the touch sensing cells is formed in the intersection of the corresponding driving line and the corresponding scanning line, the at least one capacitive temperature sensor is formed in the intersection of the corresponding driving line and the corresponding scanning line, the monitoring step comprising:
during a temperature sensing period, sequentially driving the corresponding driving lines and scanning the corresponding scanning lines to measure the capacitance change of the at least one capacitive temperature sensor so as to monitoring the change of the thermal characteristic of the at least one capacitive temperature sensor to estimate the temperature of the at least one particular location; and
during a touch sensing period, sequentially driving the corresponding driving lines and scanning the corresponding scanning lines for touch sensing.

7. The thermal control method according to claim 1, wherein the at least one capacitive temperature sensor is provided on a heat spreader of a back cover of the portable electronic device, and at least part of the heat spreader functions as an electrode of the capacitive temperature sensor.

8. A thermal control module applicable in a portable electronic device, the portable electronic device comprising at least one capacitive temperature sensor and a touch panel, the at least one capacitive temperature sensor formed on at least one particular location of the outside surface of the portable electronic device, the capacitive temperature sensor having a thermal characteristic which is temperature sensitive, the touch panel having a plurality of touch sensing cells, the thermal control module comprising:
a controller, coupled to the capacitive temperature sensor and the touch sensing cells, for determining an estimated temperature of the particular location based on a sensing result from the at least one capacitive temperature sensor and determining at least one touch position based on sensing results from the touch sensing cells; and
a thermal manager, coupled to the controller, for managing thermal throttling in the portable electronic device based on the estimated temperature of the particular location.

9. The thermal control module according to claim 8, wherein the at least one capacitive temperature sensor is formed on the particular location of the outside surface of the portable electronic device that is near the edge of the portable electronic device.

10. The thermal control module according to claim 8, wherein the at least one capacitive temperature sensor is formed on the particular location of the outside surface of the portable electronic device that is away from the location of at least one heat source of the portable electronic device.

11. The thermal control module according to claim 8, wherein the at least one capacitive temperature sensor is formed on the particular location that is near a speaker of the portable electronic device.

12. The thermal control module according to claim 8, wherein:
the touch panel has a non-sensing area and a sensing area having the touch sensing cells; and
the at least one capacitive temperature sensor has different patterns from the touch sensing cells or the at least one capacitive temperature sensor has the same patterns as the touch sensing cells.

13. The thermal control module according to claim 8, wherein:
the touch panel further comprises a plurality of driving lines and a plurality of scanning lines;
each of the touch sensing cells is formed in the intersection of the corresponding driving line and the corresponding scanning line;
the at least one capacitive temperature sensor is formed in the intersection of the corresponding driving line and the corresponding scanning line;
during a temperature sensing period, the controller sequentially drives the corresponding driving lines and scans the corresponding scanning lines to measure the capacitance change of the at least one capacitive temperature sensor so as to monitoring the change of the thermal characteristic of the at least one capacitive temperature sensor to estimate the temperature of the at least one particular location; and
during a touch sensing period, the controller sequentially drives the corresponding driving lines and scans the corresponding scanning lines for touch sensing.

14. The thermal control module according to claim 8, wherein:
the portable electronic device further comprises a back cover having a heat spreader;
the at least one capacitive temperature sensor is provided on the heat spreader; and
at least one part of the heat spreader functions as an electrode of the capacitive temperature sensor.
